(19) United States
(12) Patent Application Publication
(10) Pub. No.: US 2022/0035903 A1
(43) Pub. Date: Feb. 3, 2022

(54) PERSONALIZED SERVICE OPERATION SYSTEM AND METHOD OF SMART DEVICE AND ROBOT USING SMART MOBILE DEVICE

(71) Applicants: Hyun Min KIM, Seoul (KR); ONNURI COMPANY LC., Seoul (KR)

(72) Inventor: Hyun Min KIM, Seoul (KR)

(73) Assignees: ONNURI COMPANY LC., Seoul (KR); Hyun Min KIM, Seoul (KR)

(21) Appl. No.: 17/502,837

(22) Filed: Oct. 15, 2021

Related U.S. Application Data
(63) Continuation of application No. PCT/KR2019/014689, filed on Nov. 1, 2019.

(30) Foreign Application Priority Data
Apr. 17, 2019 (KR) 10-2019-0045158

(51) Int. Cl. G06F 21/45; H04L 29/08; G06F 21/60; B25J 9/16

(52) U.S. Cl. CPC G06F 21/45; H04L 67/10; H04M 1/72409; G06F 21/602; B25J 9/1658; H04L 67/306

(57) ABSTRACT

A cloud computing-based server includes: a personalization code information receiving unit configured to receive personalization code information from a mobile device; a feedback data receiving unit configured to receive feedback data of the service from the mobile device, the smart device or the robot; a data receiving unit configured to receive, from an information processing center, standard customized information generated based on preset criteria depending on purpose and use of the service, a standard avatar program and a standard smart program; an optimization customized information generation unit configured to generate optimization customized information based on the personalization code information, the feedback data and the standard customized information; an optimization avatar program generation unit configured to generate an optimization avatar program to be executed on the mobile device based on the personalization code information, the feedback data and the standard avatar program; and an optimization smart program generation unit.

### CROSS-REFERENCE TO RELATED APPLICATIONS

This application is a continuation of International Application No. PCT/KR2019/014689 filed on Nov. 1, 2019 which claims priority to Korean Patent Application No. 10-2019-004518 filed on Apr. 17, 2019, the entire contents of which are herein incorporated by reference.

### TECHNICAL FIELD

The present disclosure relates to technologies for providing a personalized service operation system and a method of a smart device and a robot using a smart mobile device.

### BACKGROUND

Smart mobile devices are smart devices that people carry around with them for convenience in daily life, and refer to smartphones, smart pads, smart watches and smart wearable devices.

A smart device refers to an information and communication application product which is not limited in function and most of whose functions can be changed or expanded through an application program. The smart device refers to an intelligent device which recognizes the surrounding environment of the device and moves or reacts by itself and is equipped with a communication module and voice recognition and artificial intelligence AI functions depending on the type of the device and connected to various objects based on Internet of Things (IoT) and whose functions can be controlled by text or voice.

With the expansion of the Internet and mobile infrastructure and the use of artificial intelligence (AI) technology in various fields, the hyper-connected age, in which all industries are connected as one, has come. The benefits of smart mobile devices including smartphones that implement the hyper-connected age include convenience of sending and receiving e-mails, watching videos and mobile shopping on the move, communication possibility that allows communication with many people at any time, easy accessibility to desired information from anywhere, convenience of remotely controlling various devices through an application in real time, and the like.

Cloud Computing is an innovative computing technology that provides IT-related services, such as data storage and processing, network, and content use, in a server on the Internet, which is represented as a cloud, at once. Cloud computing technology is the core of the future intelligent society, and the core technologies, such as artificial intelligence, IoT, security technology, virtual reality and augmented reality, that lead the fourth industrial revolution are all fused and connected in the cloud.

Digital twin refers to a digital copy of an object that exists in the real world. The digital twin, a technology that will peak within the next five years, already exists around us as avatars of objects not people. The digital twin, which is characterized in that various simulations can be performed by implementing physical objects in the real world into a virtual environment, is emerging as the most notable next-generation technology as the advancement of related element technologies, such as sensors, artificial intelligence (AI), Internet of Things (IoT), and 3D printing.

As we enter into the era of artificial intelligence, the question of how artificial intelligence will impact human life and business is growing. As artificial intelligence technology advances, automated intelligent systems play an increasingly important role in our daily life. Accordingly, some experts say that judgment tools to prioritize human welfare and safety need to be standardized in the development of artificial intelligence related technologies. In particular, the argument that we should try to put human values and personality into artificial intelligence technology is gaining momentum.

Further, although the world is changing rapidly due to artificial intelligence, many experts point out it is too soon to think that the real era of artificial intelligence is coming soon. This is because artificial intelligence will not be able to easily penetrate the realm of human reason and emotion due to the limitations of artificial intelligence technology based on big data and algorithms. Since the proportion of artificial intelligence technology is still not high in real life and industries, more innovative means of use and technology development are needed to widely use artificial intelligence in real life.

### SUMMARY

### Problems to be Solved by the Invention

The present disclosure is conceived to enable a user to personalize and use a smart device or robot by using a smart mobile device. The present disclosure provides a personalized service operation system and method of a smart device or robot by using a smart mobile device, which enables a user to receive a personalized information service optimized for the user's personal characteristics from the personalized device and use a personalized function.

The present disclosure is also conceived to enable a user to use a cyber avatar of a smart device or robot in a smart mobile device. Thus, when the user goes out, the user can communicate with the avatar by text, voice or image while receiving a personalized information service through the avatar, and can also monitor the service conditions and surrounding environment of the smart device or robot or remotely control the functions of the smart device or robot at home or in the office through the avatar. The present disclosure provides a system and method for operating an avatar of a smart device or robot registered for use through a smart mobile device of a user.

The present disclosure is also conceived to enable a user to directly provide a smart program and personalized information to a smart device or robot by using a smart mobile device via near field communication and to enable the smart device or robot to provide a personalized service optimized for the user's personal characteristics. The present disclosure provides a system and method for providing a personalized service to a user by personalizing a smart device or robot by using a smart mobile device via near field communication.

The problems to be solved by the present disclosure are not limited to the above-described problems. There may be other problems to be solved by the present disclosure.

### Means for Solving the Problems

To solve the above-described problem, according to at least one example embodiment, it is possible to provide, a cloud computing-based server that provides a user's personalized service, comprising a personalization code information receiving unit configured to receive, from a mobile device, personalization code information including personal registration information registered in a personalization application installed on the mobile device and personal characteristic information required to personalize a service depending on the type of a smart device or a robot linked to the personalization application; a feedback data receiving unit configured to receive feedback data of the service from the mobile device, the smart device or the robot; a data receiving unit configured to receive, from an information processing center, standard customized information generated based on preset criteria depending on purpose and use of the service, a standard avatar program and a standard smart program; an optimization customized information generation unit configured to generate optimization customized information based on the personalization code information, the feedback data and the standard customized information; an optimization avatar program generation unit configured to generate an optimization avatar program to be executed on the mobile device based on the personalization code information, the feedback data and the standard avatar program; an optimization smart program generation unit configured to generate an optimization smart program to be executed on the smart device or the robot based on the personalization code information, the feedback data and the standard smart program; and an optimization program transmission unit configured to transmit the optimization avatar program to the mobile device and the optimization smart program to the smart device or the robot.

According to at least one other example embodiment, it is possible to provide, a method to provide a user's personalized service based on cloud computing, comprising receiving, from a mobile device, personalization code information including personal registration information registered in a personalization application installed on the mobile device and personal characteristic information required to personalize a service depending on the type of a smart device or a robot linked to the personalization application; receiving feedback data of the service from the mobile device, the smart device or the robot; receiving, from an information processing center, standard customized information generated based on preset criteria depending on purpose and use of the service, a standard avatar program and a standard smart program; generating optimization customized information based on the personalization code information, the feedback data and the standard customized information; generating an optimization avatar program to be executed on the mobile device based on the personalization code information, the feedback data and the standard avatar program; generating an optimization smart program to be executed on the smart device or the robot based on the personalization code information, the feedback data and the standard smart program; transmitting the optimization avatar program to the mobile device; transmitting the optimization smart program to the smart device or the robot; transmitting the optimization customized information to the mobile device; and transmitting the optimization customized information to the smart device or the robot.

According to at least one other example embodiment, it is possible to provide, a computer program stored in a non-transitory medium to provide a user's personalized service based on cloud computing, comprising: a sequence of instructions to receive, from a mobile device, personalization code information including personal registration information registered in a personalization application installed on the mobile device and personal characteristic information required to personalize a service depending on the type of a smart device or a robot linked to the personalization application, receive feedback data of the service from the mobile device, the smart device or the robot, receive, from an information processing center, standard customized information generated based on preset criteria depending on purpose and use of the service, a standard avatar program and a standard smart program, generate optimization customized information based on the personalization code information, the feedback data and the standard customized information, generate an optimization avatar program to be executed on the mobile device based on the personalization code information, the feedback data and the standard avatar program, generate an optimization smart program to be executed on the smart device or the robot based on the personalization code information, the feedback data and the standard smart program, transmit the optimization avatar program to the mobile device, transmit the optimization smart program to the smart device or the robot, transmit the optimization customized information to the mobile device, and transmit the optimization customized information to the smart device or the robot.

According to at least one other example embodiment, it is possible to provide, a system that provides a user's personalized service, comprising a cloud computing-based server; an information processing center configured to generate standard customized information generated based on preset criteria depending on purpose and use of the service, a standard avatar program and a standard smart program; a mobile device on which a personalization application and an optimization avatar program are executed; and a smart device or a robot on which an optimization smart program is executed, wherein the cloud computing-based server includes a personalization code information receiving unit configured to receive, from the mobile device, personalization code information including personal registration information registered in the personalization application installed on the mobile device and personal characteristic information required to personalize a service depending on the type of the smart device or the robot linked to the personalization application, a feedback data receiving unit configured to receive feedback data of the service from the mobile device, the smart device or the robot, a data receiving unit configured to receive, from the information processing center, the standard customized information generated based on preset criteria depending on purpose and use of the service, the standard avatar program and the standard smart program, an optimization customized information generation unit configured to generate optimization customized information based on the personalization code information, the feedback data and the standard customized information, an optimization avatar program generation unit configured to generate an optimization avatar program to be executed on the mobile device based on the personalization code information, the feedback data and the standard avatar program, an optimization smart program generation unit configured to generate an optimization smart program to be executed on the smart device or the robot based on the personalization code information, the feedback data and the standard smart program, an optimization program transmission unit configured to transmit the optimization avatar program to the mobile device and the optimization smart program to the smart device or the robot, and an optimization customized information transmission unit configured to transmit the optimization customized information to the mobile device and the smart device or the robot.

Above-mentioned means for solving the problems are provided by way of illustration only and should not be construed as limiting in any manner. Besides the above-described exemplary embodiments, there may be additional exemplary embodiments that become apparent by reference to the drawings and the detailed description that follows.

### Effects of the Invention

According to any one of the above-described aspects of the present disclosure, a user can personalize a smart device or robot for various purposes as a personalized device optimized for his/her personal characteristics by using a smart mobile device. The user can receive a personalized service which is upgraded as it is used through the personalized device. Accordingly, it is possible to increase the availability of smart devices or robots and thus possible to contribute to the promotion of human welfare and the development of related industries.

That is, a smart artificial intelligence assistant device, a smart speaker, a smart toy, a smart doll, a smart health care device, a smart robot, a smart pet robot, a smart learning device, a smart living device, a smart pet device, a smart religion device, a smart virtual experience device, a smart industrial device, a smart medical device or a smart security device on which a smart operation program according to the present disclosure is installed can be easily personalized as a personalized device through a system of the present disclosure by using a smart mobile device on which the user has installed a personalization application according to the present disclosure. The user can receive a personalized service optimized for the user's personal characteristics from the personalized smart device or robot.

Also, the present disclosure enables the user to use a cyber avatar of the smart device or robot on the smart mobile device. Thus, when the user goes out, the user can receive a personalized information service through the avatar. Also, the user can communicate with the avatar by text, voice or image and can also monitor the service conditions and surrounding environment of the smart device or robot or remotely control the functions of the smart device or robot at home or in the office through the avatar. Accordingly, it is possible to provide convenience to the user regardless of the use space of the smart device or robot.

Further, the present disclosure enables the user to personalize and use the smart device by using the smart mobile device via near field communication. Therefore, the user can easily personalize and use a smart toy, a smart doll, a smart pet robot, a smart wearable device, a smart pet device or a smart health care device, which is equipped with a Bluetooth module and a smart function and is cheap, as a personalized device optimized for the user without the burden of communication cost.

### BRIEF DESCRIPTION OF THE DRAWINGS

FIG. 1 shows a configuration of a system for providing a user's personalized service according to an embodiment of the present disclosure.

FIG. 2 is a diagram illustrating an example structure of personalization code information according to an embodiment of the present disclosure.

FIG. 3 to FIG. 5 are flowcharts of a method for providing the user's personalized service according to an embodiment of the present disclosure.

### DETAILED DESCRIPTION

Hereafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Through the whole document, the term “unit” includes a unit implemented by hardware, a unit implemented by software, and a unit implemented by both of them. One unit may be implemented by two or more pieces of hardware, and two or more units may be implemented by one piece of hardware. However, the “unit” is not limited to the software or the hardware and may be stored in an addressable storage medium or may be configured to implement one or more processors. Accordingly, the “unit” may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and functions provided in the “units” can be combined with each other or can be divided up into additional components or “units”. Further, the components and the “units” may be configured to implement one or more CPUs in a device or a secure multimedia card.

Hereinafter, embodiments of the present disclosure will be described in detail with reference to the accompanying drawings.

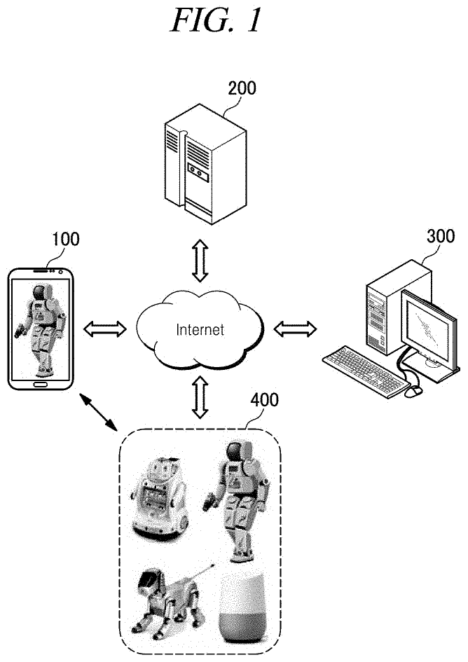

FIG. 1 shows a configuration of a system for providing a user's personalized service according to an embodiment of the present disclosure. Referring to FIG. 1, the system for providing the user's personalized service may include a smart mobile device 100, a server 200, an information processing center 300 and a smart device or robot 400.

A personalization application having an algorithm may be installed on the smart mobile device 100. The algorithm processes the input personal registration information and personal characteristic information of the user into personalization code information and provides the personalization code information to the server 200 via a network.

The information processing center 300 may operate a cloud computing-based database. The information processing center 300 may collect public data and various information from public institutions, specialized institutions, schools, organizations, companies and the like, and may process the information using an artificial intelligence and big data program.

The information processing center 300 may classify customized information, which has been produced by experts in various fields by processing the collected information for various conditions, and may store the customized information in the database. The information processing center 300 may collect feedback data from users for each condition through a user platform of the smart device or robot 400, analyze the feedback data using the artificial intelligence and big data program, produce customized information suitable for purpose and use of the users for each condition based on the analyzed feedback data and store the customized information in the database.

The information processing center 300 may store personalized information, which is prepared by matching the customized information stored in the database with the standard personalization code information according to the algorithm, in the database. The information processing center 300 may register use information of the smart device or robot 400, prepare an avatar program and a smart program to be used in each device based on the use information and store these programs in the database. The information processing center 300 may share the personalized information, the use information, the avatar program and the smart program with the server 200 via the network and organically manage them.

The server 200 may manage information for each account based on cloud computing. The server 200 may receive the personalization code information from the smart mobile device 100, generate a personal ID based on the personalization code information and share the personal ID with the smart mobile device 100.

The server 200 may extract the use information of the smart device or robot 400 from the database of the information processing center 300, share the use information with the smart mobile device 100 and manage use registration information of the smart device or robot 400.

The server 200 may extract the personalized information, the avatar program and the smart program from the database of the information processing center 300, personalize each of them based on the personalization code information and match them with the personal ID to prepare customized information for personal ID, an avatar program for personal ID and a smart program for personal ID, and then may store them in a personal ID account of the database.

When the server 200 receives the use registration information of the smart device or robot 400 through the smart mobile device 100, the personal ID account may provide the avatar program for personal ID and the customized information for personal ID to the smart mobile device 100 via the network according to the algorithm. The server 200 may provide the smart program for personal ID and the customized information for personal ID to the smart device or robot 400.

The smart device or robot 400 may be equipped with a smart function and a smart operation program that performs a function and service suitable for use. The smart device or robot 400 may receive the smart program for personal ID and the customized information for personal ID provided from the server 200 via the network based on the personal ID provided by the smart mobile device 100 according to an algorithm of the smart operation program. Based on this, the smart device or robot 400 may provide a personalized service.

Therefore, when the user executes the personalization application on the smart mobile device 100 and inputs the use information of the smart mobile device 100 by allowing an NFC tag or a QR code to be scanned by the smart device or robot 400 to be personalized, the use registration information of the smart device or robot 400 including a personal ID may be transmitted from the smart mobile device 100 to the server 200.

The server 200 may extract the avatar program for personal ID, the smart program for personal ID and the customized information for personal ID from the personal ID account based on the use registration information according to the algorithm. The server 200 may provide the avatar program for personal ID and the customized information for personal ID to the smart mobile device 100 via the network, and the smart program for personal ID and the customized information for personal ID to the smart device or robot 400 that shares the personal ID. Accordingly, each device provides a personalized service to the user.

Accordingly, the user may interact and communicate with each device by text, voice or image while receiving a personalized service optimized for the user through the smart mobile device 100 and the smart device or robot 400 that share the personal ID. Also, the user may use a personalized service which is upgraded as it is used based on data accumulated in the system 100 to 400.

The cloud computing-based database whose data are shared by the server 200 and the information processing center 300 systematically performs an advanced management of the avatar program for personal ID and the smart program for personal ID based on customized information for personal ID in the personal ID account according to the algorithm. Accordingly, a personalized service optimized for the user's personal characteristics can be provided by each device.

The server 200 operates the artificial intelligence and big data program in order to efficiently perform a personalized service, and connects the smart mobile device 100, the information processing center 300 and the smart device or robot 400 via a cloud network to operate the system (FIG. 1). The server 200 organically performs an advanced management of the smart mobile device 100 and the smart device or robot 400 according to the algorithm to provide a personalized service optimized for the user.

The personalization application installed on the smart mobile device 100 by the user through an app store or QR code recognition is an application program executed on the smart mobile device 100. The personalization application converts the input personal registration information and personal characteristic information of the user into personalization code information and stores the personalization code information according to the algorithm.

When the user registers for use of the smart device or robot 400, the personalization application sequentially presents a pull-down menu (additional information) necessary to personalize these devices to the user. When the user selects a corresponding item, it is converted into code information to generate personalization code information. Personalization code information accumulated through the personalization application may be processed into encapsulated data and transmitted to the server 200.

Also, the personalization application may collect and optimize personalization data generated by interaction with the user by text, voice or image based on the personal ID, data of the smart mobile device 100 and data of the application that shares the personal ID according to the algorithm for upgrading the personalized service, and then may transmit the optimized data to the server 200.

Further, the personalization application may receive the avatar program for personal ID and the customized information for personal ID provided from the server 200 via the network based on the personal ID and combine the avatar program for personal ID and the customized information for personal ID for optimization according to the algorithm. Based on this, the personalization application may execute a cyber avatar of the smart device or robot 400 on the screen of the smart mobile device 100 to provide a personalized information service optimized for the user.

When the cyber avatar of the smart device or robot 400 is executed on the smart mobile device 100, the service conditions of the smart device or robot 400, which is the real object, can be monitored or functionally controlled through the avatar using the digital twin technology that implements a digital copy of an object that exists in the real world into a virtual environment. Also, various simulations can be performed through the avatar.

Therefore, the user on the move can communicate with the smart device or robot 400 at home or in the office and remotely control the functions of the smart device or robot 400 while using the personalized information service optimized for the user through the avatar of the smart mobile device 100. Based on this, personal data can be accumulated, and the personalized information service can be upgraded through the system.

The personal registration information is personal information registered by the user in the personalization application, and is composed of the user's country of residence, language, birth year, biometric authentication information and additional information. As for the personal registration information, when the user selects an item from a sub-menu of the personal information sequentially presented on the screen of personal registration according to the algorithm of the personalization application, selected information of the personal information is converted into personalization code information.

The personalization code information may be processed into encapsulated data having a packet structure composed of, for example, [header (flag+control information)+country code+language code+birth year+biometric authentication information+additional information+trailer], and may be transmitted to the server 200 to generate a personal ID.

The biometric authentication information is issued based on biometric information, such as fingerprint recognition, iris recognition, and face recognition of the user, stored in the smart mobile device 100. When the user registers the personal registration information in the personalization application, the biometric authentication information is included in the encapsulated data according to the algorithm.

The additional information is a personal identification means that supplements the biometric authentication information. The password, e-mail, and fingerprint recognition, iris recognition and face recognition, which are not used as biometric authentication information, can be used as additional information means depending on the user's selection.

The personal characteristic information is composed of a plurality of pieces of characteristic information necessary to personalize a function and service of the device depending on the type of the smart device or robot 400 registered for use in the personalization application.

The characteristic information may include personal information, body information, health information, exercise information, job information, professional information, business information, hobby information, talent information, personality information, psychological information, interest information and additional information necessary for a personalized service of the smart device or robot.

When the user selects each suitable item from a sub-menu of the characteristic information sequentially presented on the screen of use registration according to the algorithm of the personalization application, personalization code information of the personal characteristic information can be systematically generated.

The personalization code information may be combined with, for example, a personal ID and processed into encapsulated data having a packet structure composed of [header (flag+control information)+personal ID+personalization code information+encryption code+trailer], and then may be transmitted to the server 200. The sub-menu of the characteristic information may be selected by text, voice or image depending on the type of the device and the level of the user and then presented to the user.

The server 200 may collect personalization code information of users and data generated by the smart mobile device 100 and the smart device or robot 400, analyze them using the artificial intelligence and big data program and produce personalized information and predictive information based on the analyzed personalization code information and data. The server 200 may store customized information for personal ID, which is produced by matching the personalized information and predictive information with each personal ID, in a personal ID account and provide the upgraded personalized information service to each user.

When the user selects the cyber avatar of the smart device or robot 400 recommended on the screen of use registration or inputs avatar use registration information through QR code recognition, the personalization application may transmit the avatar use registration information to the server 200 based on the personal ID according to the algorithm.

The personalization application may receive and optimize the avatar program for personal ID and the customized information for personal ID provided by the server 200. Based on this, the personalization application may display the avatar on the screen of the smart mobile device 100 or through external projection (hologram, projector, etc.). The user can communicate with the avatar by text, voice or image while receiving a personalized information service optimized for the user through the avatar.

Accordingly, the user may select a favorite avatar from among avatars recommended in a list on the use registration screen of the smart mobile device 100 and use the avatar independently without being linked to the smart device or robot 400. If the user purchases and uses the smart device or robot 400 packaged with an avatar, when the user registers for use on the smart mobile device 100, places the smart device or robot 400 at home or in the office and goes out, the user can monitor the service conditions and surrounding environment of the smart device or robot 400 or remotely control the functions of the smart device or robot 400 through the avatar and can also remotely control household items or office machines connected via the Internet of Things through an avatar by text and voice.

The information processing center 300 uses the artificial intelligence and big data program to collect information from various fields and produce personalized information optimized for the user's conditions (e.g., country, language, age, gender, occupation, taste, etc.). In order to suppress the occurrence of errors in customized information and implement people-oriented technology, the information processing center 300 verifies and optimizes personalized information processed in various conditions through cooperation of experts in various fields via a network and then stores the personalized information in the cloud computing-based database and shares the personalized information with the server 200.

Also, the information processing center 300 may operate a user platform depending on the type of the smart device or robot 400, collect feedback data from users for each condition (e.g., country, language, age, gender, occupation, taste, etc.), analyze the feedback data using the artificial intelligence and big data program, prepare personalized information optimized for each condition, an avatar program and a smart program based on the analyzed feedback data and store the prepared personalized information, avatar program and smart program in the database. The information processing center 300 may operate the cloud computing-based database via a cloud network for global services and share personalized information, which is produced by experts in various fields from various countries in local language and sensibility, with the server 200.

Accordingly, the information processing center 300 provides personalized information so that the smart device or robot 400 can be used in a personalized manner optimized for the user. For example, children and students whose personal characteristics change rapidly as they grow up may be provided with personalized information (e.g., learning information, talent information) which is systematically produced and optimized in stages depending on age group and learning conditions. For example, office workers or businessmen may be provided with personalized information (e.g. professional information, analysis information, business information) required in each field, and in this case, the personalized information may be optimized for the user's personal characteristic information.

The personal ID may be generated, for example, by converting the biometric authentication information of the personal registration information into encapsulated data having a packet structure composed of [header (flag+control information)+country code+language code+birth year+biometric authentication conversion information+encryption code+trailer] according to the algorithm of the server 200 for personal identification information protection and communication security, and a compression code that can be used interchangeably with the personal ID is also generated and managed together.

Further, in addition to the personal ID, a compression code (e.g., a combination of alphabets, numbers and special characters) that can be used interchangeably with the personal ID is also generated and managed according to the algorithm for the efficiency of network transmission and communication security. Thus, when data are exchanged between the server 200 and the smart mobile device 100 and the smart device or robot 400, the compression code may be used instead of the personal ID. The data transmitted when the compression code is used may be processed into encapsulated data having a packet structure composed of [header (flag+control information)+compression code+data+encryption code+trailer].

When the compression code is used instead of the personal ID, communication conditions for decrypting the compression code are automatically set in the personalization application, the avatar program for personal ID and the smart program for personal ID according to the algorithm of the server 200. Thus, communication security can be maintained high by the encryption code that is periodically changed.

The server 200 collects data of the smart mobile device 100 and the smart device or robot 400 that share a personal ID for each personal ID account according to the algorithm, analyzes the data using the artificial intelligence and big data program and optimizes the customized information for personal ID, the avatar program for personal ID and the smart program for personal ID based on the analyzed data to upgrade the personalized service.

Further, the server 200 performs an advanced management of the avatar program for personal ID and the smart program for personal ID based on the customized information for personal ID for each personal ID account, and organically optimizes the avatar program for personal ID and the smart program for personal ID to perform an advanced management of the personalized service.

Furthermore, the server 200 may collect data of the smart mobile device 100 using the avatar program for personal ID and data of the smart device or robot 400 using the smart program for personal ID based on the personal ID according to the algorithm, and may process the collected data as synchronization data. The server 200 may provide the synchronization data to the smart mobile device 100 and the smart device or robot 400 that share the personal ID to synchronize the devices used by the user.

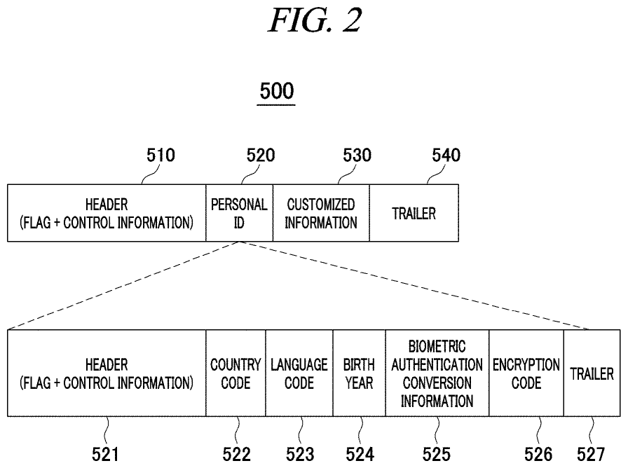

As for the customized information for personal ID, customized information is prepared through personalization based on the personalization code information according to the algorithm of the server 200 and matched with the personal ID and then processed into encapsulated data having a packet structure composed of [header (flag+control information)+personal ID+customized information+encryption code+trailer]. A configuration of the encapsulated data of the customized information for personal ID will be described below in detail with reference to FIG. 2.

The avatar program for personal ID is an application program that executes the cyber avatar of the smart device or robot 400 on the smart mobile device 100. The avatar program for personal ID is combined for optimization according to the algorithm of the personalization application, and uses an artificial intelligence platform depending on the device. The avatar program for personal ID receives the customized information for personal ID from the server 200 based on the personal ID according to the algorithm, and provides the personalized information service to the user through the avatar based on the customized information for personal ID. The avatar program for personal ID enables the user to communicate with the avatar by text, voice or image and also enables the user to remotely control the functions of the smart device or robot 400 while monitoring the service conditions and surrounding environment of the smart device or robot 400 through the avatar. Data accumulated through the above-described process are optimized, and the personalized information service is upgraded based on the optimized data.

The smart program for personal ID is an application program that executes functions and services of the smart device or robot 400 in a personalized manner. The smart program for personal ID is combined according to the algorithm of the smart operation program, and uses the artificial intelligence platform depending on the device.

The smart program for personal ID may receive the customized information for personal ID from the server 200 based on the personal ID according to the algorithm, and may provide the personalized information service to the user based on the customized information for personal ID. The smart program for personal ID personalizes and executes the smart function in a personalized manner. Accordingly, the smart program for personal ID optimizes the data accumulated by interaction with the user and upgrades the personalized service based on the optimized data.

The smart function is executed by the smart operation program and the smart program depending on a voice input and a response of the sensor in the smart device or robot 400. According to the smart function, various sensors installed on the device may recognize the surrounding environment, and, thus, the device may move or react by itself and may integrate various objects around it via the network. The device may be equipped with a voice recognition function and an artificial intelligence solution depending on the device and thus may communicate with the user by text, voice or image. Also, according to the smart function, various household items or office machines connected via the network through the Internet of Things (IoT) function can be remotely controlled by text and voice.

The smart operation program is a system program installed on the smart device or robot 400 to execute a function and service depending on purpose and use of the device, and uses the artificial intelligence platform depending on the device. The smart operation program receives the smart program for personal ID and the customized information for personal ID provided based on the personal ID from the server 200 via the network or through the smart mobile device 100 via near field communication according to the algorithm, combines the smart program for personal ID and the customized information for personal ID for optimization for characteristics of the device, and executes the personalized service based on this.

The smart mobile device 100 includes a smartphone, a smart pad, a smart watch and a smart wearable device with a personalization application installed thereon. The smart mobile device 100 receives and optimizes the avatar program for personal ID and the customized information for personal ID based on the personal ID through the network according to an algorithm of the personalization application. Accordingly, the smart mobile device 100 may communicate with the user while providing the personalized information service to the user through the avatar. The avatar may be displayed as a 3D character or image on the screen or through external projection (projector, hologram, etc.) depending on the device.

Smart watches and wearable devices that have been widely used in recent years have built-in cameras, artificial intelligence and augmented reality (AR) functions, and are holographic wearable devices that can be controlled by clicking on a virtual screen popped up in the air are also being commercialized. Therefore, even in a smart wearable device, which is a kind of smart mobile device 100, the user can display the customized information for personal ID (e.g., video, image, 3D character, etc.) to the outside in various ways through the avatar using a projector or a hologram.

The smart device or robot 400 includes a smart artificial intelligence assistant device, a smart speaker, a smart toy, a smart doll, a smart health care device, a smart robot, a smart pet robot, a smart learning device, a smart living device, a smart pet device, a smart religion device, a smart virtual experience device, a smart industrial device, a smart medical device and a smart security device on which the smart operation program is installed.

The smart device or robot 400 receives the smart program for personal ID and the customized information for personal ID provided based on the personal ID from the server 200 via the network or through the smart mobile device 100 via near field communication according to the algorithm of the smart operation program and provides the personalized service to users based on the smart program for personal ID and the customized information for personal ID.

Further, when the smart mobile device 100 provides the use registration information including the personal ID by allowing an NFC tag or a QR code to be scanned, the smart device or the robot 400 receives the smart program for personal ID and the customized information for personal ID provided based on the personal ID through the smart mobile device 100 via near field communication according to the algorithm of the smart operation program. The smart device or robot 400 may execute the personalized service in response to the user, optimize the customized information for personal ID and interaction data accumulated in the device, and execute the smart function of the device in a personalized manner.

Therefore, a method of personalizing the smart device or the robot 400 using near field communication such as Bluetooth on the smart mobile device 100 may be used when it is difficult to connect to connect the smart device or the robot 400 to a wide area network at all times due to communication security or communication cost. Also, it is a useful means for personalizing and using a smart toy, a smart doll, a smart pet robot, a smart health care device, a smart exercise device, a smart religion device and a smart security device equipped with a Bluetooth module.

When the smart mobile device 100 carried by the user comes close to the smart device or robot 400 used at home or in the office, the smart device or robot 400 may be automatically connected (paired) with the smart mobile device 100 that shares the personal ID via near field communication according to the algorithm of the smart operation program. Accordingly, the smart device or robot 400 may recognize the user who gets close to the smart device or robot 400 and may react favorably (e.g. greeting, waving, dancing) to the user or may communicate with the user by voice, and may automatically perform personalized functions (e.g., opening a door, turning on a light, etc.) set by the user.

In order to describe the present disclosure in more detail, various embodiments according to the present disclosure will be described as follows. Hereinafter, there will be described a case where the user uses his or her smartphone as the smart mobile device 100 and uses a smart artificial intelligence assistant device as the smart device or robot 400.

<Information Input to Smartphone and Stages of Algorithm>

Stage 1: The user installs a personalization application on the smartphone.

Stage 2: The user selects an item suitable for him or her from a sub-menu of personal registration information (e.g., country of residence, language, birth year, biometric authentication information) and personal characteristic information (e.g., personal information, health information, occupation information, etc.) that are sequentially presented on the registration screen of the personalization application according to an algorithm or input information by text, voice or image.

Stage 3: The personalization application converts the input personal registration information and personal characteristic information into personalization code information, processes the personalization code information into encapsulated data, transmits the personalization code information to the server 200, receives a personal ID generated by the server 200 and stores the personal ID.

Stage 4: The user selects device registration on the registration screen of the personalization application, and inputs use registration information by allowing an NFC tag or a QR code of the smartphone to be scanned by the smart artificial intelligence assistant device.

Stage 5: The user selects an item suitable for him or her from a pull-down menu (list of questions), which is required to optimize the smart artificial intelligence assistant device for personal characteristics, on the smartphone or input by text, voice or image in response to the questions.

<Personalized Information Produced by Information Processing Center 300 and Stages of Algorithm>

Stage 1: Information collected in various fields is classified using an artificial intelligence and big data program, and based on this, experts in various fields optimize the collected information for various conditions to produce customized information, and personalized information produced by matching the customized information with standard personal characteristic information is stored in a database and shared with the server 200.

Stage 2: Feedback data from users of smart artificial intelligence assistant devices are collected through a user platform and analyzed the data using the artificial intelligence and big data program, and based on this, customized information optimized for the users for each condition is produced and matched with the standard personal characteristic information to produce personalized information. The produced personalized information is stored in the database and shared with the server 200.

Stage 3: A company that supplies smart artificial intelligence assistant devices receives use information of devices, registers the use information in the database, prepares an avatar program and a smart program for use in smartphones and smart artificial intelligence assistant devices based on the use information, stores the programs in the database and shares the programs with the server 200.

<Stages of Algorithm of Server 200>

Stage 1: Personalization code information transmitted from the personalization application on the smartphone is received, and based on this, a personal ID and a compression code are generated and shared with the user's smartphone.

Stage 2: The personalized information provided by the information processing center 300 is matched with the user's personalization code information and personal ID, and based on this, customized information for personal ID, an avatar program for personal ID and a smart program for personal ID are prepared and stored in a personal ID account.

Stage 3: When the use registration information (NFC/QR code information) including a network address and the personal ID is received from the smartphone and smart artificial intelligence assistant device, the avatar program for personal ID and the customized information for personal ID are provided to the smartphone and the smart program for personal ID and the customized information for personal ID are provided to the smart artificial intelligence assistant device based on the personal ID.

Stage 4: Data generated by communication between the user and the smart artificial intelligence assistant device are collected using the avatar program for personal ID and the smart program for personal ID executed on each device, analyzed using the artificial intelligence and big data program, and upgraded. Based on this, customized information for personal ID which is upgraded as it is used is generated and provided to the smartphone and the smart artificial intelligence assistant device.

<Stages of Algorithm of Personalization Application on Smartphone>

Stage 1: The avatar program for personal ID and the customized information for personal ID provided from the server 200 are received and combined for optimization based on the personal ID.

Stage 2: When the user executes a cyber avatar of the smart artificial intelligence assistant device in the personalization application, the avatar communicates with the user by text, voice or image while providing a personalized information service optimized for the user based on the customized information for personal ID accumulated in the device.

Stage 3: When the user goes out with the smartphone, the avatar is automatically connected to the smart artificial intelligence assistant device at home or in the office. Thus, the user can continuously communicate with the avatar by text, voice or image and can also monitor the surrounding environment of the device through the avatar or remotely control household items, household appliances or office machines connected via the Internet of Things (IoT) through the avatar.

Stage 4: The communication data and remote control data generated by interaction between the user and the avatar are processed and provided to the server 200.

Stage 5: The customized information for personal ID and communication data accumulated in the device are upgraded by an artificial intelligence microcontroller (AI MCU) built in the smartphone and the avatar program for personal ID to provide the personalized information service, which is upgraded as it is used, through the avatar.

<Stages of Algorithm of Smart Artificial Intelligence Assistant Device>

Stage 1: The smart program for personal ID and the customized information for personal ID provided from the server 200 are received and combined for optimization based on the personal ID.

Stage 2: The customized information for personal ID which is continuously provided via the network is accumulated and optimized to provide the personalized information service based on this while emotional communication is performed with the user.

Stage 3: The customized information for personal ID and communication data accumulated in the device are optimized by the built-in artificial intelligence microcontroller (AI MCU) and the smart program for personal ID to provide the upgraded personalized information service to the user.

Stage 4: The communication data and remote control information data are provided to the server 200 by the smart program for personal ID.

Stage 5: When the user goes out, the server 200 provides customized information of the smart artificial intelligence assistant device, surrounding environment information, and remote control information to the smartphone.

Stage 6: When the user carrying the smartphone comes close to the smart artificial intelligence assistant device, the smart artificial intelligence assistant device automatically recognizes the smartphone based on the personal ID, performs preset smart functions (e.g., opening a door, turning on a light, etc.) or greets and communicates with the user by voice, and provides the personalized information service.

When the user selects and registers an avatar on the registration screen of the smartphone, a virtual assistant or a virtual character (e.g., 3D character, video, hologram, etc.) representing a celebrity may be selected from an avatar recommendation list displayed on the screen and may be used as the avatar instead of the real image of the smart artificial intelligence assistant device depending on the user's taste.

Hereinafter, there will be described a case where the user uses his or her smart phone as the smart mobile device 100 and uses a smart robot as the smart device or robot 400. Since the execution process in the case of using the smart robot is similar to that in the case of using the artificial intelligence assistant device described above, detailed description thereof will be omitted and the effect thereof will be described.

The user can personalize the smart robot using his or her smartphone and optimize the smart robot for his or her age and personal characteristics. Thus, the smart robot can be personalized and used as the user's robot for education or pet robot.

That is, the smart robot receives and accumulates the customized information for personal ID and the smart program for personal ID provided through the server 200, and can respond quickly and flexibly to personal questions and requests about the user's personal characteristic information (e.g., country of residence, language, age, gender, health, occupation, taste, etc.) based on the customized information for personal ID and the smart program for personal ID. Also, the smart robot is upgraded in communication skill as it is used and can communicate emotionally with the user based on the accumulated customized information for personal ID. Therefore, the smart robot can be used as a pet robot that relieves loneliness, a robot for education, a robot for treatment (e.g., for dementia treatment), etc.

Further, when the user goes out, the user can call a cyber avatar of the smart robot with his or her smartphone and communicate intimately with the avatar while receiving a personalized information service through the avatar. Furthermore, the user can monitor the surrounding environment of the smart robot at home or in the office through the avatar or remotely control the functions of the smart robot through the avatar. Also, the user can remotely control household items, household appliances or office machines connected via the Internet of Things (IoT) through the avatar by voice. Thus, the user can live a convenient life.

Accordingly, the present disclosure can also be effectively used to create personalized services for the disadvantaged, such as the elderly, the disabled and patients, who are liable to be marginalized from the benefits of rapidly developing artificial intelligence and advanced technologies.

For example, when the elderly and the disabled who are physically less capable use the smart robot, the smart robot 400 is optimized for the user's personal characteristics through the user's smartphone and provides a personalized service as follows.

When the user executes the personalization application on his or her smartphone, inputs his or her personal characteristic information according to a menu presented on the screen of personal registration and allows an NFC tag of the smartphone to be scanned by the smart robot, the server 200 provides the smart robot with the customized information for personal ID and the smart program for personal ID, which are prepared based on the user's personal characteristic information, via the network. Therefore, the smart robot operates as a personalized robot optimized for the user's personal characteristics based on the customized information for personal ID and the smart program for personal ID.

Accordingly, the elderly can relieve loneliness while communicating intimately with the smart robot optimized for their personal characteristics (e.g., age, gender, occupation, hobbies, health care, etc.). Also, the smart robot optimized for their personal characteristics may be used as a pet robot to serve as a domestic helper suitable for them or for rehabilitation treatment and dementia prevention. The disabled can communicate with the smart robot by text, voice or image while receiving a personalized information service (e.g., customized information suitable for the type of disability) from the smart robot optimized for their personal characteristics (e.g., age, occupation, hobbies, health, disability, etc.). Thus, the disabled can live a convenient life by using a personalized robot to overcome a handicap.

The smart device or robot 400 may be manufactured as a smart doll of various shapes depending on purpose and use. The smart doll can provide personalized information by emotional voice customized as the user likes based on the smart program for personal ID and the customized information for personal ID, which are optimized for the user's personal characteristic information (e.g., country, language, age, gender, occupation, hobbies, taste, etc.) and provided through the server 200. The smart doll communicates intimately with the user like a friend or a lover, and can operate the smart functions intelligently and can be upgraded as it is used. Thus, the smart doll can communicate emotionally and flexibly with the user.

Also, when the user goes out, he or she can use a cyber avatar of the smart doll on the smartphone. Thus, the user can communicate intimately with the avatar by text, voice or image while continuously receiving a personalized information service through the avatar. Further, the user can monitor the surrounding environment of the smart doll at home or in the office through the avatar and thus live a convenient life.

If the present disclosure is applied as described above to a smart toy, a smart health care device, a smart pet robot (a robot looking like a pet), a smart learning device, a smart living device, a smart pet device, a smart religion device, a smart industrial device, a smart medical device, a smart virtual experience device, a smart security device, a smart IoT application device, etc. which are not described in the embodiment, as the smart device or robot 400, the same effect as obtained in the above-described execution process of the present disclosure can be obtained.

Therefore, when the user registers for use of all of his or her smart devices or robots 400 on his or her smart mobile device 100, data of all the devices are accumulated in the personal ID account and the server 200 can perform an advanced management based on the accumulated data according to the algorithm. The user may receive a personalized service optimized for personal characteristics in three dimensions through all the smart devices or robots 400 registered for use on the smart mobile device 100.

FIG. 2 is a diagram illustrating an example structure of personalization code information according to an embodiment of the present disclosure. FIG. 2 illustrates a personal ID and a configuration of exemplary encapsulated data of customized information for personal ID according to an embodiment of the present disclosure.

Referring to FIG. 2, encapsulated data 500 of the customized information for personal ID may be composed of, for example, [header (flag+control information 510)+personal ID/compression code 520+customized information 530+trailer 540]. The personal ID/compression code 520 may be composed of [header (flag+control information 521)+country code 522+language code 523+birth year 524+biometric authentication conversion information 525+encryption code 526+trailer 527]. The control information may include an information classification code and an information generation date.

The embodiment of processing the customized information for personal ID into encapsulated data having a packet structure is provided to efficiently process the data when the customized information for personal ID transmitted from the server 200 is received by the smart mobile device 100 and the smart device or robot 400. By using this, the customized information for personal ID can be classified for each condition and stored according to control information (e.g., classification code, generation date) in each device and can be systematically processed for optimization.

Also, the encryption code 526 for communication security and a network address can be added to the encapsulated data packet that communicates based on the personal ID and then transmitted according to an encryption algorithm of the server 200. The smart mobile device 100 and the smart device or robot 400 that receive the encapsulated data decrypt and execute the encapsulated data according to the algorithm.

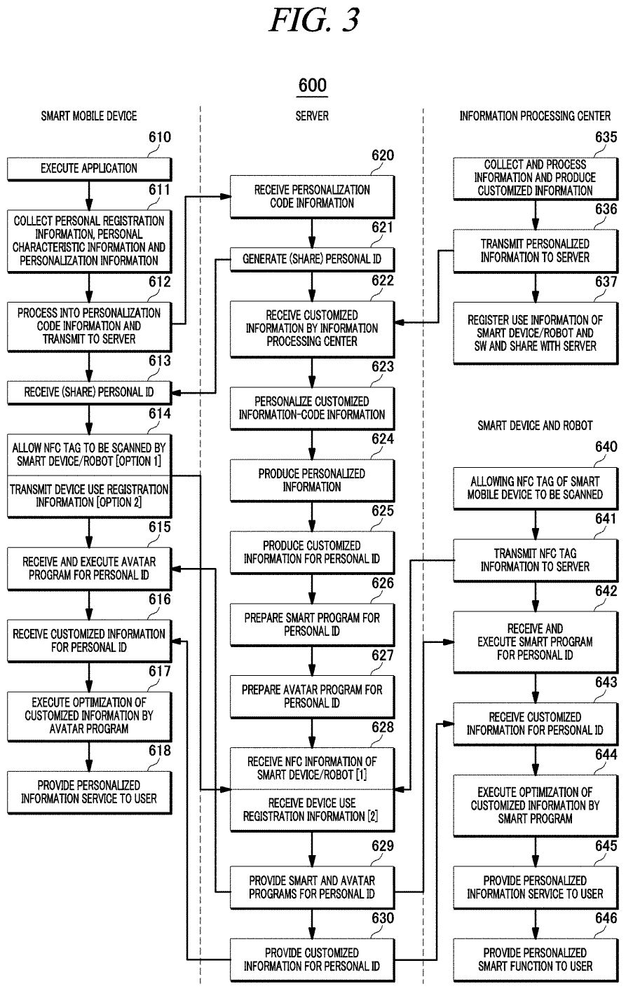

Referring to FIG. 3, a method 600 for operating a personalized service of a smart device or robot using a smart mobile device of the present disclosure includes process a to i to be described below.

The process a includes: a process of executing a personalization application on the smart mobile device (610); a process of collecting input personal registration information, personal characteristic information and personalization information accumulated by interaction (611) and processing the collected information into personalization code information and transmitting the personalization code information to a server (612); a process of receiving personalization code information from the server (620), generating a personal ID based on the personalization code information in the server (621) and sharing the personal ID with the smart mobile device (613); a process of producing personalized information by processing information collected by an information processing center from public institutions, specialized institutions, schools, companies, etc. (635) and transmitting the produced personalized information to the server (636); and a process of registering use information of the smart device or robot, preparing a standard avatar program and a smart program used in each device based on the use information, and sharing the avatar program and the smart program with the server by the information processing center (637).

The process b includes a process of personalizing customized information for an individual user based on a personalization code information according to an algorithm in the server (623) to produce personalized information (624), matching the personalized information with a personal ID to produce customized information for personal ID (625), matching the customized information for personal ID with the personal ID based on the personalization code information to prepare a smart program for personal ID (626), and preparing an avatar program for personal ID (627).

The process c includes a process of allowing an NFC tag of the smart mobile device to be scanned by the smart device or robot by the user (option 1) or registering use registration information of the smart device or robot on the registration screen of the personalization application through a QR code by the user and transmitting the use registration information to the server (option 2) (614).

The process d includes: a process of allowing the NFC tag of the smart mobile device to be scanned by the smart device or robot (640); and a process of transmitting NFC tag information (including the personal ID) from the smart device or robot to the server (641).

The process e includes: a process of extracting the avatar program for personal ID from a personal ID account by the server and providing the avatar program for personal ID to the smart mobile device via a network (629); and a process of executing the avatar program for personal ID on the smart mobile device (615).

The process f includes: a process of extracting the customized information for personal ID from the personal ID account by the server and providing the customized information for personal ID to the smart mobile device via the network (630); a process of receiving the customized information for personal ID by the smart mobile device (616); and a process of executing the customized information for personal ID by the avatar program for personal ID (617).

The process g includes: a process of extracting the smart program for personal ID from the personal ID account by the server and providing the smart program for personal ID to the smart device or robot, which shares the personal ID, via the network (629); and a process of receiving the smart program for personal ID by the smart device or robot and executing the smart program for personal ID by a smart operation program (642).

The process h includes: a process of extracting the customized information for personal ID from the personal ID account by the server and providing the customized information for personal ID to the smart device or robot via the network (630); and a process of executing the customized information for personal ID on the smart device or robot by the smart operation program (644) and providing a personalized information service (645, 618) and a personalized smart function (646) while interacting with the user based on the customized information for personal ID.

The process i includes: a process of extracting the customized information for personal ID from the personal ID account by the server and providing the customized information for personal ID to the smart device or robot via the network (630); and a process of receiving the customized information for personal ID by the smart device or robot (643), processing the customized information for personal ID by a smart program and executing a personalized service (645, 646) while interacting with the user based on the customized information for personal ID.

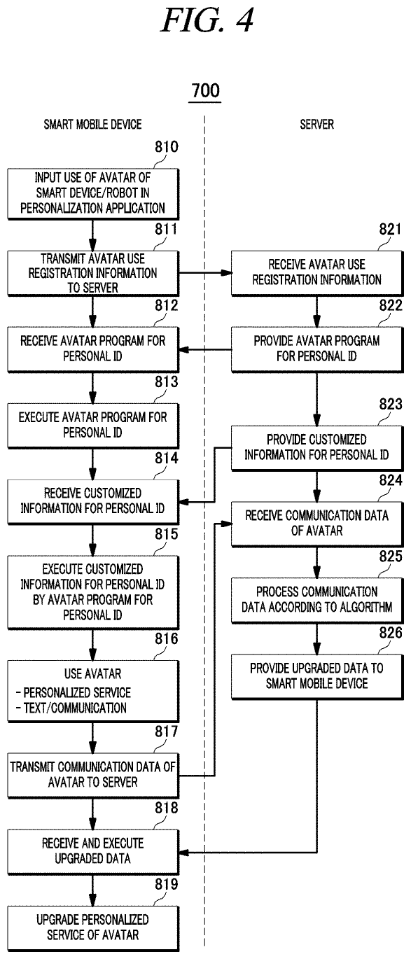

FIG. 4 is a flowchart of a method 700 for executing an avatar of a smart device or robot on a smart mobile device according to an embodiment of the present disclosure. The method 700 may be performed after the process b of the method 600 described above.

The method 700 includes: a process of selecting a cyber avatar of the smart device or robot from an avatar recommendation list or inputting use information on an avatar use registration screen of the personalization application (810); a process of transmitting avatar use registration information including the personal ID to the server (811); a process of receiving the avatar use registration information from the server (821) and providing the avatar program for personal ID to the smart mobile device (822); and a process of receiving the avatar program for personal ID by the smart mobile device (812) and combining the avatar program for personal ID with the personalization application to execute the avatar program for personal ID (813).

The method 700 further includes: a process of providing the customized information for personal ID from the server to the smart mobile device (823); and a process of receiving the customized information for personal ID by the smart mobile device (814), executing the customized information for personal ID by the avatar program for personal ID (815), communicating with the user by text, voice or image while interacting with the user based on the customized information for personal ID through the avatar (816) and transmitting communication data of the avatar to the server by the avatar program for personal ID (817).

The method 700 further includes: a process of receiving the communication data of the avatar by the server (824), upgrading the communication data of the avatar based on the customized information for personal ID according to the algorithm (825) and providing the upgraded data to the avatar program for personal ID (826); and a process of receiving the upgraded data by the smart mobile device, executing the avatar on the screen of the smart mobile device or through external projection (818) and upgrading the personalized information service (819).

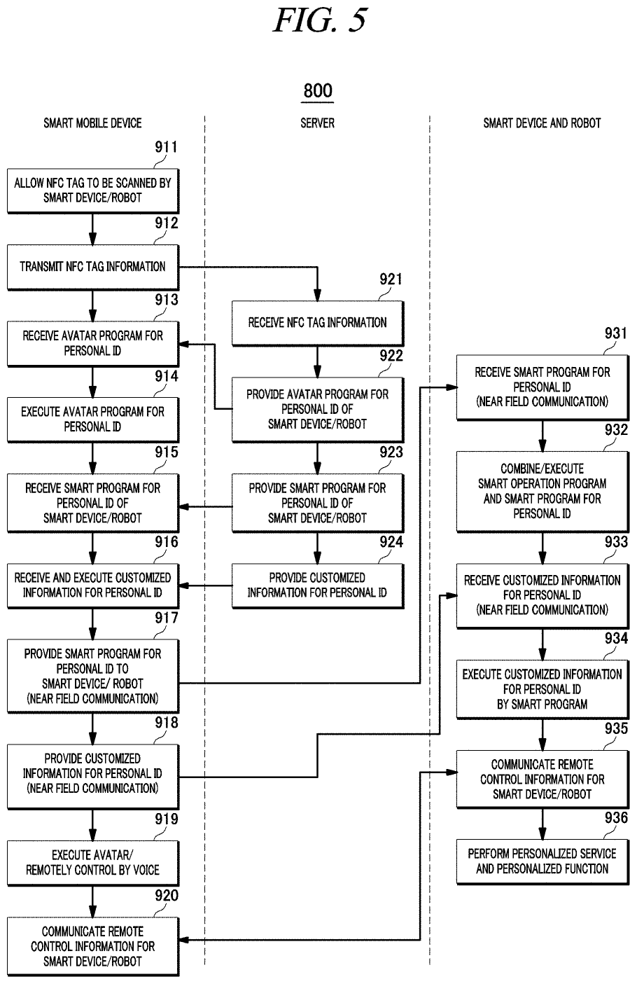

FIG. 5 is a flowchart of a method 800 for personalizing a smart device or robot on a smart mobile device in a personalized manner via near field communication according to an embodiment of the present disclosure. The method 800 may be performed after the process b of the method 600 described above.

The method 800 includes: a process of transmitting NFC tag information including the use registration information of the smart device or robot and the personal ID to the server through the smart mobile device (912) by clicking on a use registration menu of the smart device or robot on a device use registration screen of the personalization application and allowing an NFC tag to be scanned by the smart device or robot (911); and a process of receiving the NFC tag information by the server (921) and providing the avatar program for personal ID to the smart mobile device (922).

The method 800 also includes: a process of receiving the avatar program for personal ID by the smart mobile device (913) and combining the avatar program for personal ID with the personalization application to execute the avatar program for personal ID (914); a process of providing the smart program for a personal ID from the server to the smart mobile device (923); a process of receiving the smart program for personal ID by the smart mobile device (915); a process of providing the customized information for personal ID from the server to the smart mobile device (924); and a process of receiving the customized information for personal ID by the smart mobile device and executing the customized information for personal ID by the avatar program for personal ID (916).

The method 800 further includes: a process of providing the smart program for personal ID to the smart device or a robot from the smart mobile device via near filed communication (917); a process of receiving the smart program for personal ID by the smart device or robot (913), combining the smart program for personal ID by the smart operation program to execute the smart program for personal ID (932); a process of providing the customized information for personal ID by the smart mobile device via near field communication (918); and a process of receiving the customized information for personal ID by the smart device or robot (933) and executing the customized information for personal ID by the smart program (934).

The method 800 also includes: a process of communicating remote control information 919 for controlling a function of the smart device or robot via near field communication through the avatar on the smart mobile device (920); a process of communicating between the smart device or robot and the smart mobile device via near filed communication (935) and executing the function of the smart device or robot based on the remote control information of the avatar (920 to 936); and a process of communicating between the user and the smart device or robot by text, voice or image while receiving the personalized information service from the smart device or robot and using a personalized function (936).

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A cloud computing-based server that provides a user's personalized service, comprising:
a personalization code information receiving unit configured to receive, from a mobile device, personalization code information including personal registration information registered in a personalization application installed on the mobile device and personal characteristic information required to personalize a service depending on a type of a smart device or a robot linked to the personalization application;
a feedback data receiving unit configured to receive feedback data of the service from the mobile device, the smart device or the robot;
a data receiving unit configured to receive, from an information processing center, standard customized information generated based on preset criteria depending on purpose and use of the service, a standard avatar program and a standard smart program;
an optimization customized information generation unit configured to generate optimization customized information based on the personalization code information, the feedback data and the standard customized information;
an optimization avatar program generation unit configured to generate an optimization avatar program to be executed on the mobile device based on the personalization code information, the feedback data and the standard avatar program;
an optimization smart program generation unit configured to generate an optimization smart program to be executed on the smart device or the robot based on the personalization code information, the feedback data and the standard smart program; and
an optimization program transmission unit configured to transmit the optimization avatar program to the mobile device and the optimization smart program to the smart device or the robot.

2. The cloud computing-based server of claim 1, further comprising:
a storage unit configured to store the personalization code information, the optimization customized information, the optimization avatar program and the optimization smart program.

3. The cloud computing-based server of claim 1,
wherein the personalization code information includes biometric authentication information generated based on biometric information registered in the mobile device.

4. The cloud computing-based server of claim 3,
wherein the personalization code information further includes additional identification information that supplements the biometric authentication information.

5. The cloud computing-based server of claim 1, further comprising:
a use registration information receiving unit configured to receive, from the smart device or the robot, use registration information to identify a user,
wherein the optimization program transmission unit is further configured to transmit the optimization avatar program corresponding to the use registration information to the mobile device and the optimization smart program corresponding to the use registration information to the smart device or the robot.

6. The cloud computing-based server of claim 5, further comprising:
an optimization customized information transmission unit configured to transmit the optimization customized information corresponding to the use registration information to the mobile device and the smart device or the robot.

7. The cloud computing-based server of claim 6, further comprising:
an encryption code generation unit configured to generate a compression code in which communication conditions for decryption in the mobile device and the smart device or the robot are automatically set.

8. The cloud computing-based server of claim 7,
wherein the optimization customized information transmission unit is further configured to transmit a data packet including the compression code corresponding to the use registration information to the mobile device and the smart device or the robot.

9. The cloud computing-based server of claim 8,
wherein the data packet including the compression code further includes an encryption code that is periodically changed.

10. The cloud computing-based server of claim 5,
wherein the use registration information receiving unit is further configured to receive, from the smart device or the robot, the use registration information that has been received by the smart device or the robot from the mobile device.

11. The cloud computing-based server of claim 5,
wherein when a distance between the mobile device and the smart device or the robot is within a predetermined range, the use registration information receiving unit is further configured to receive, from the smart device or the robot, the use registration information that has been automatically received by the smart device or the robot from the mobile device.

12. The cloud computing-based server of claim 1, further comprising:
an information processing center transmission unit configured to transmit the feedback data, the optimization customized information, the optimization avatar program and the optimization smart program to the information processing center.

13. The cloud computing-based server of claim 1,
wherein the optimization program transmission unit is further configured to transmit the optimization avatar program and the optimization smart program to the mobile device in order to transmit the optimization smart program from the mobile device to the smart device or the robot via near field communication.

14. The cloud computing-based server of claim 1, further comprising:
a synchronization data receiving unit configured to receive, from the mobile device and the smart device or the robot, synchronization data to synchronize the optimization avatar program with the optimization smart program in real time.

15. The cloud computing-based server of claim 14,
wherein the optimization avatar program generation unit is further configured to update the optimization avatar program executed on the mobile device further based on the synchronization data, and
the optimization smart program generation unit is further configured to update the optimization smart program executed on the smart device or the robot further based on the synchronization data.

16. A method to provide a user's personalized service based on cloud computing, comprising:
receiving, from a mobile device, personalization code information including personal registration information registered in a personalization application installed on the mobile device and personal characteristic information required to personalize a service depending on a type of a smart device or a robot linked to the personalization application;
receiving feedback data of the service from the mobile device, the smart device or the robot;
receiving, from an information processing center, standard customized information generated based on preset criteria depending on purpose and use of the service, a standard avatar program and a standard smart program;
generating optimization customized information based on the personalization code information, the feedback data and the standard customized information;
generating an optimization avatar program to be executed on the mobile device based on the personalization code information, the feedback data and the standard avatar program;
generating an optimization smart program to be executed on the smart device or the robot based on the personalization code information, the feedback data and the standard smart program;
transmitting the optimization avatar program to the mobile device;
transmitting the optimization smart program to the smart device or the robot;
transmitting the optimization customized information to the mobile device; and
transmitting the optimization customized information to the smart device or the robot.

17. A non-transitory computer readable medium storing a computer program to provide a user's personalized service based on cloud computing, the computer program comprising:
a sequence of instructions to
receive, from a mobile device, personalization code information including personal registration information registered in a personalization application installed on the mobile device and personal characteristic information required to personalize a service depending on the type of a smart device or a robot linked to the personalization application,
receive feedback data of the service from the mobile device, the smart device or the robot,
receive, from an information processing center, standard customized information generated based on preset criteria depending on purpose and use of the service, a standard avatar program and a standard smart program,
generate optimization customized information based on the personalization code information, the feedback data and the standard customized information,
generate an optimization avatar program to be executed on the mobile device based on the personalization code information, the feedback data and the standard avatar program,
generate an optimization smart program to be executed on the smart device or the robot based on the personalization code information, the feedback data and the standard smart program,
transmit the optimization avatar program to the mobile device,
transmit the optimization smart program to the smart device or the robot,
transmit the optimization customized information to the mobile device, and
transmit the optimization customized information to the smart device or the robot.

18. A system that provides a user's personalized service, comprising:
a cloud computing-based server;
an information processing center configured to generate standard customized information generated based on preset criteria depending on purpose and use of the service, a standard avatar program and a standard smart program;
a mobile device on which a personalization application and an optimization avatar program are executed; and
a smart device or a robot on which an optimization smart program is executed,
wherein the cloud computing-based server includes
a personalization code information receiving unit configured to receive, from the mobile device, personalization code information including personal registration information registered in the personalization application installed on the mobile device and personal characteristic information required to personalize a service depending on the type of the smart device or the robot linked to the personalization application,
a feedback data receiving unit configured to receive feedback data of the service from the mobile device, the smart device or the robot,
a data receiving unit configured to receive, from the information processing center, the standard customized information generated based on preset criteria depending on the purpose of use of the service, the standard avatar program and the standard smart program,
an optimization customized information generation unit configured to generate optimization customized information based on the personalization code information, the feedback data and the standard customized information,
an optimization avatar program generation unit configured to generate an optimization avatar program to be executed on the mobile device based on the personalization code information, the feedback data and the standard avatar program,
an optimization smart program generation unit configured to generate an optimization smart program to be executed on the smart device or the robot based on the personalization code information, the feedback data and the standard smart program,
an optimization program transmission unit configured to transmit the optimization avatar program to the mobile device and the optimization smart program to the smart device or the robot, and
an optimization customized information transmission unit configured to transmit the optimization customized information to the mobile device and the smart device or the robot.

19. The system of claim 18,
wherein the server further includes
an information processing center transmission unit configured to transmit the feedback data, the optimization customized information, the optimization avatar program and the optimization smart program to the information processing center, and
the information processing center is further configured to
receive, from the server, the feedback data, the optimization customized information, the optimization avatar program and the optimization smart program,
update the standard customized information based on the feedback data and the optimization customized information,
update the standard avatar program based on the feedback data and the optimization avatar program, and
update the standard smart program based on the feedback data and the optimization smart program.

20. The system of claim 18,
wherein the server further includes
a synchronization data receiving unit configured to receive, from the mobile device and the smart device or the robot, synchronization data to synchronize the optimization avatar program with the optimization smart program in real time, and
the mobile device is configured to
remotely control the smart device or the robot according to the optimization avatar program.
